(19) United States
(12) Patent Application Publication
(10) Pub. No.: US 2004/0001073 A1
(43) Pub. Date: Jan. 1, 2004

(54) Device having a display

(76) Inventor: Jan Chipchase, Tokyo (JP)

Correspondence Address: SCHEEF & STONE, L.L.P., 5956 SHERRY LANE, SUITE 1400, DALLAS, TX, 75225, US

(21) Appl. No.: 10/185,157

(22) Filed: Jun. 27, 2002

(51) Int. Cl. G09G 5/00

(52) U.S. Cl. 345/619

(57) ABSTRACT

A predetermined task is associated with a visually identifiable area at a predetermined position outside the display area of a device. Movement of an element from the display area towards the visually identifiable area at the predetermined position initiates the predetermined task.

### BACKGROUND OF THE INVENTION

The present invention relates to a device for carrying out tasks having a display.

A user of a device with a display does not intuitively know how to carry out tasks effectively. Often a device, such as a mobile phone, has a complex menu structure and a very large number of steps are required to carry out simple and often repeated tasks. In addition processor hungry tasks will take time to complete and the display may be occupied during this time.

### BRIEF SUMMARY OF THE INVENTION

According to one aspect of the invention there is provided a device for performing a predetermined task associated with a visually identifiable area of the device, comprising a display and a front face having a display area for the display and at least one visually identifiable area at a predetermined position outside the display area wherein movement of an element across at least a portion of the display area towards the visually identifiable area at the predetermined position initiates the associated predetermined task.

According to another aspect of the invention there is provided a device for performing a predetermined task associated with a visually identifiable area of the device face, comprising: a display; a front face having a display area for the display and at least one visually identifiable area at a predetermined position outside the display area; sensing means for sensing movement of an element across at least a portion of the display area towards the visually identifiable area at the predetermined position; and control means, responsive to the sensing means, arranged to initiate the associated predetermined task when an element is moved across at least a portion of the display area towards the visually identifiable area at the predetermined position.

According to another aspect of the invention there is provided a method of performing a predetermined task associated with a visually identifiable area at a predetermined position outside the display area of a device, comprising the step of: moving an element from the display area towards the visually identifiable area at the predetermined position.

For a better understanding of the present invention reference will now be made by way of example only to the drawings in which:

### BRIEF DESCRIPTION OF THE DRAWINGS

FIG. 1 illustrates a device for performing a predetermined task;

FIG. 2 illustrates a device displaying an icon for performing a predetermined task;

FIG. 3 illustrates a first embodiment of a device for performing a predetermined task;

FIG. 4 illustrates a second embodiment of a device for performing a predetermined task;

FIGS. 5a and 5b illustrate a third embodiment of a device for performing a predetermined task; and

FIG. 6 illustrates a cover of a device for performing a predetermined task displaying an icon.

### DETAILED DESCRIPTION OF THE INVENTION

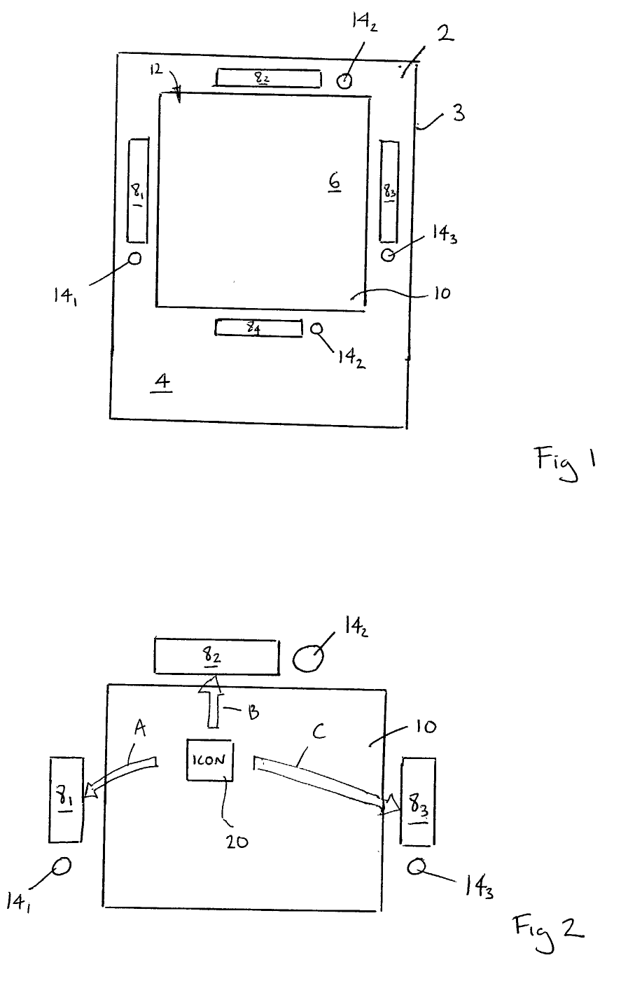

FIG. 1 illustrates a device 2 comprising a housing 3 and a display 10. The device, in this example, is a hand-portable mobile device such as a mobile phone or a personal digital assistant. The device has a front face 4 and an opening 12 in the housing 3 to the display 10. The front face 4 of the device 2 has a display area 6 coincident with the opening 12 where the display 10 is visible and first 8₁, second 8₂, third 8₃ and fourth 8₄ visually identifiable areas 8ₙ of the housing 3. In this example, the display area 6 is rectangular and there is a separate visually identifiable area 8ₙ adjacent each side of the rectangle. Each of the first 8₁, second 8₂, third 8₃ and fourth 8₄ visually identifiable areas has respectively an adjacent associated indicator 14₁, 14₂, 14₃ and 14₄. The indicator uses an LED.

The visually identifiable areas 8ₙ are at predetermined positions. They may be visually identified by their location at predetermined positions on the front face 4 (e.g. adjacent the edges of the display area 6) being otherwise unremarkable, or they may be visually identified by conspicuous and distinctive signs on the front face 4 at the predetermined positions. The signs at each of the visually identifiable areas 8ₙ may be different from each other. The signs may be permanently recorded on the front face 4 or each visually identifiable area may comprise a separate display for displaying a sign.

Each visually identifiable area 8ₙ has one predetermined task associated with it. Movement of an element from the display area 6 towards a particular visually identifiable area 8ₘ initiates the associated task. The element which is moved may be an icon 20 displayed on the display 10, or a finger or pointing device either touching or just in front of the display 10.

In other embodiments there may be more or less visually identifiable areas 8ₙ. The display area 6 may have a different shape. More than one visually identifiable area 8 may be adjacent one side of the display area 6. Although the indicators 14 are illustrated as being adjacent their respective visually identifiable areas 8ₙ they may alternatively be located within their respective visually identifiable areas 8ₙ. The predetermined task associated with a particular visually identifiable area 8ₙ may be reprogrammed by a user. If the visually identifiable area comprises a display the sign in the display will be changed to indicate the newly programmed task.

The predetermined tasks include running different applications, simulating a plurality of user input commands and using data in a particular way. For example, data which is used to display an image on the display 10 or is represented by an icon 20 on the display 10 may be moved to a predetermined storage location. The storage location may be the message inbox of the device, Java application memory, a local memory, a removable memory or a remote server or other storage means. Different visually identifiable areas 8ₙ may be associated with storage of data in a different storage locations. Music, video, email, photos are just some of the file formats that can be stored. A predetermined task may also be the equivalent of a number of user input actions. For example the predetermined task may cause an application to be started and selected data to be used by that application e.g. a selected photo may be opened in the photo editor application. The predetermined task may even open the photo in a photo editor application, add a copyright notice, send the altered image to a remote server and forward a copy to another user. Moving an element from the display area 6 towards a particular visually identifiable area 8ₘ to perform a particular predetermined task considerably reduces the number of steps required to perform that task.

Embodiments of the invention can take advantage of a user's spatial awareness. For example, in one embodiment moving the element towards the user saves data on local storage whereas moving the element away from the user towards the top of the device stores data on a remote server. Additionally, moving the element to the side or into the air without crossing the boundary of the display area 6 deletes the data with or without user confirmation being required.

While a predetermined task is being performed the status of the process can be identified via the indicator 14ₙ associated with that task via the associated visually identifiable area 8ₙ and the display 10 can be freed for other uses. When a LED is used as an indicator 14ₙ colour, intensity, animation, or flickering can be used to show that a task is being performed or is complete. Therefore processor hungry tasks (i.e. transferring a folder of photos) which take time to complete will not occupy the display 10 and the device 2 can be used for multi-tasking. This is particularly useful in mobile devices which have relatively small display sizes.

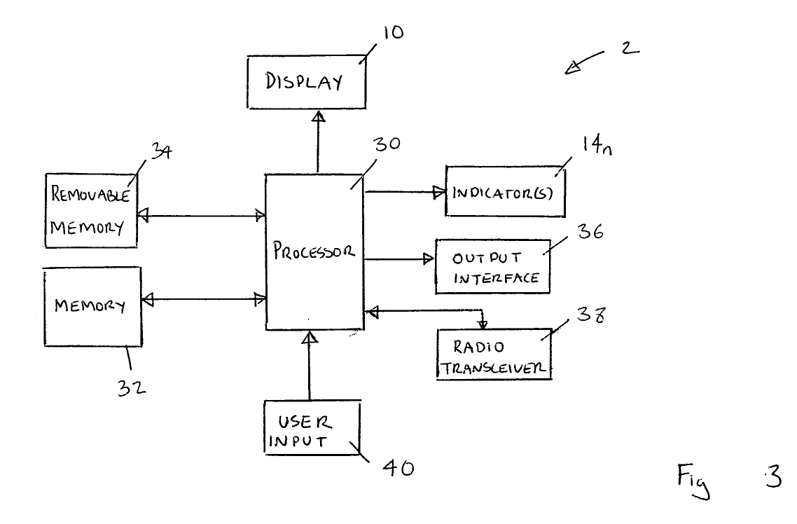

Referring to FIG. 2, the element, which is moved from the display area 6 towards a particular visually identifiable area 8ₙ to initiate the associated task, may be an icon 20 displayed on the display 10, or a finger or pointing device either touching or just in front of the display 10. The arrows A, B and C in the Figure respectively illustrate the separate movements of the element towards the first 8₁, second 8₂ and third 8₃ visually identifiable areas to initiate separate predetermined tasks.

In embodiments in which a finger or pointing device either touching or just in front of the display 10 is used as the element, which is moved from the display area 6 towards a particular visually identifiable area 8ₙ to initiate the associated task, data for use in one of the predetermined tasks may be visually represented on the display 10, for example as an icon 20. Preferably as the element, which is either touching or just in front of the display 10, is moved the icon 20 is moved underneath the element across the display 10. Therefore an icon 20 can be dragged from its location on the display and dropped into the appropriate visually identifiable area 8ₙ to initiate a predetermined task. The selected icon 20 may alternatively or additionally be highlighted.

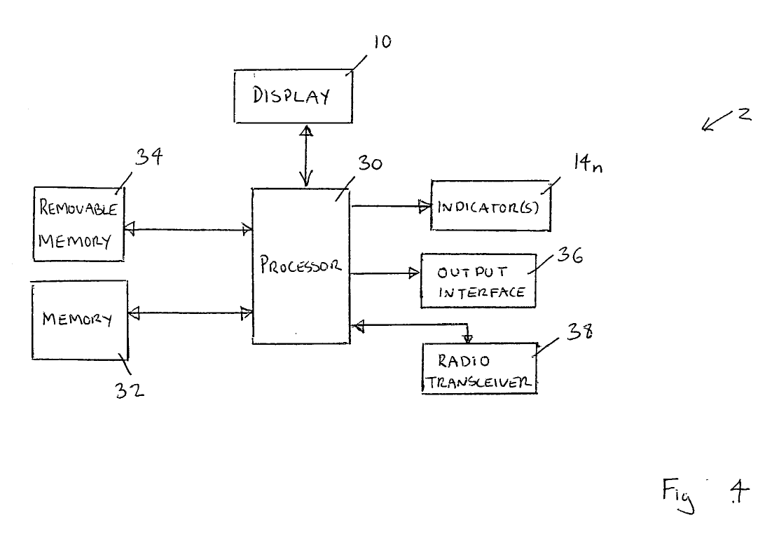

FIG. 3 is a schematic illustration of the functional components of the device 2 according to a first embodiment. In this embodiment, the element, which is moved from the display area 6 towards a particular visually identifiable area 8ₙ to initiate the associated task, is an icon 20 displayed on the display 10. Only as many components are illustrated as is necessary to describe this embodiment.

FIG. 3 illustrates a device 2 comprising a processor 30 connected to each of a display 10, indicator(s) 14ₙ, an output interface 36, a radio transceiver 38, a memory 32, a removable memory 34 and a user input control 40. The processor 30 controls the display 10 and the indicator(s) 14ₙ. It receives commands from the user input control 40 and it can transfer data to each of the output interface 36, the radio transceiver 38, the memory 32 and the removable memory 34 and can receive data from each of the radio transceiver 38, the memory 32 and the removable memory 34. The output interface 36 and the radio transceiver 38 may be used to access a remote server (not shown). The processor 30 is controlled by a program which controls the device 2 to operate in accordance with the invention and defines the predetermined tasks performed by the device 2. These tasks may include storage of data in the removable memory 34, storage of data in the local memory 32 and storage of data at a remote server using either the output interface 36 or the radio transceiver 38. The task associated with a particular visually identifiable area 8ₙ may be varied by the user using the user input control 40.

The user input control 40 preferably comprises a cursor control device for selecting and moving an icon 20 displayed on the display 10. The processor 30 senses when the icon 20 is moved across the display 10 towards a particular visually identifiable area 8ₙ. It can differentiate whether the icon 20 is being moved to the first, second etc visually identifiable area 8ₙ. The processor 30, then, having sensed the movement, initiates the task associated with that particular visually identifiable area 8ₙ. The processor 30 may sense when the icon 20 is moved across the display 10 towards a particular visually identifiable area 8ₙ by detecting when the icon 20 is moved into a boundary of the display 10 or detecting when it is moved at speed along a particular trajectory.

FIG. 4 is a schematic illustration of the functional components of the device 2 according to a second embodiment. In this embodiment, the element, which is moved from the display area 6 towards a particular visually identifiable area 8ₙ to initiate the associated task, is a finger or pointing device touching the display 10. Only as many components are illustrated as is necessary to describe this embodiment.

FIG. 4 illustrates a device 2 comprising a processor 30 connected to each of a touch sensitive display 10, indicator(s) 14ₙ, an output interface 36, a radio transceiver 38, a memory 32 and a removable memory 34. The processor 30 controls the touch sensitive display 10 and the indicator(s) 14ₙ. It receives commands from the touch sensitive display 10 and it can transfer data to each of the output interface 36, the radio transceiver 38, the memory 32 and the removable memory 34 and can receive data from each of the radio transceiver 38, the memory 32 and the removable memory 34. The output interface 36 and the radio transceiver 38 may be used to access a remote server (not shown). The processor 30 is controlled by a program which controls the device 2 to operate in accordance with the invention and defines the predetermined tasks performed by the device 2. These tasks may include storage of data in the removable memory 34, storage of data in the local memory 32 and storage of data at a remote server using either the output interface 36 or the radio transceiver 38. The task associated with a particular visually identifiable area 8ₙ may be varied by the user.

The touch sensitive display 10 informs the processor 10 of the movement of an element in front of and touching the display 10 across the display surface. The processor 30 senses when the element is moved across the display towards a particular visually identifiable area 8ₙ. It can differentiate whether the element is being moved to the first, second etc visually identifiable area 8ₙ. The processor 30, then, having sensed the movement, initiates the task associated with that particular visually identifiable area 8ₙ. The processor 30 may sense when the element is moved across the display 10 towards a particular visually identifiable area 8 by detecting when the element is moved into a boundary of the display 10 or detecting when it is moved at speed along a particular trajectory.

The display 10 may display an icon 20 and may move the icon 20 across the display 10 along with the element. The user initiates a task by touching the area of the display 10 where the icon 20 is located and then dragging it towards the particular visually identifiable area 8ₙ associated with that task.

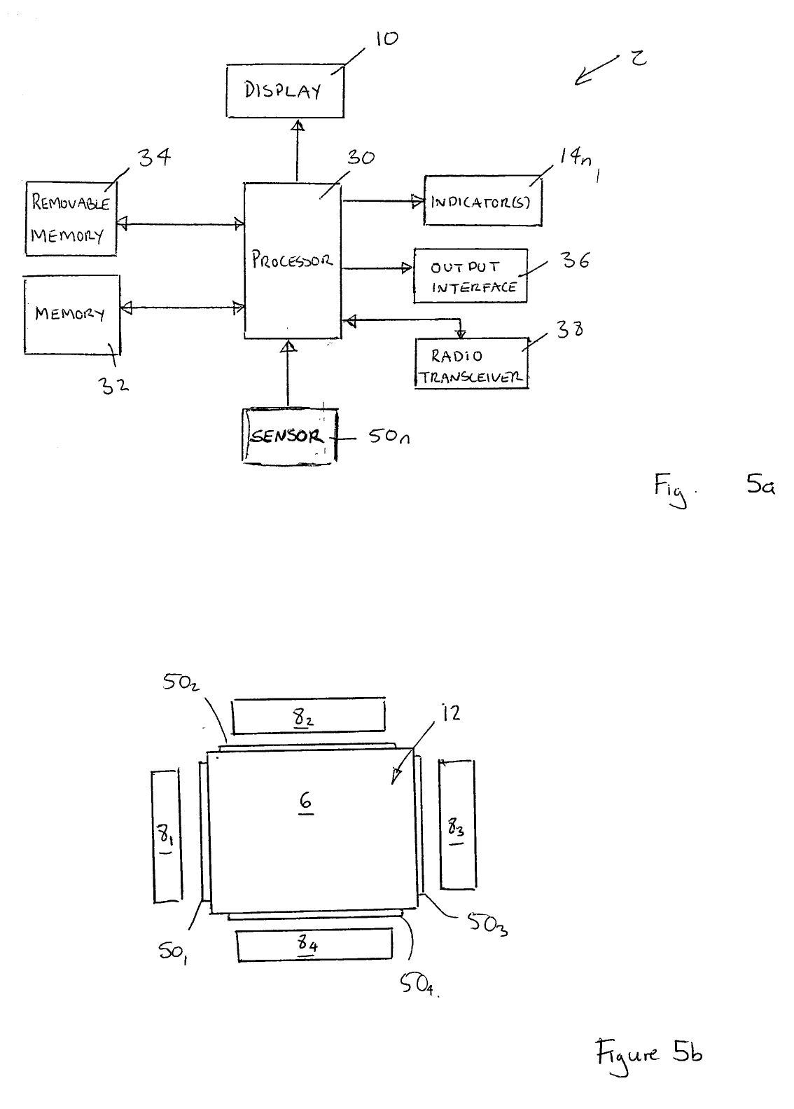

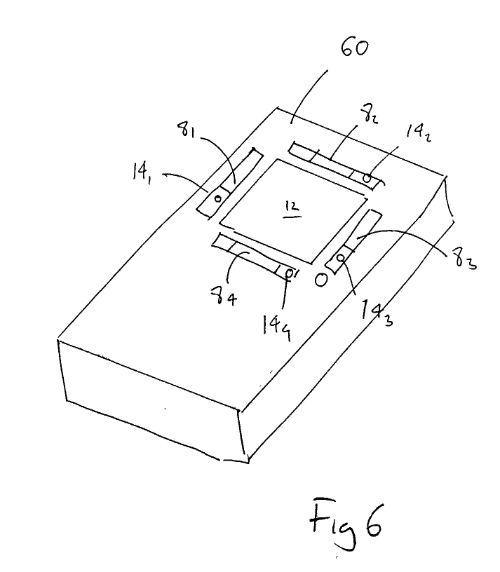

FIG. 5a is a schematic illustration of the functional components of the device 2 according to a third embodiment. In this embodiment, the element, which is moved from the display area 6 towards a particular visually identifiable area 8ₘ to initiate the associated task, is a finger or pointing device either touching the display 10 or just in front of, but not touching, the display 10. Only as many components are illustrated as is necessary to describe this embodiment.

FIGS. 5a and 5b illustrates a device 2 comprising a processor 30 connected to each of a display 10, indicator(s) 14ₙ, an output interface 36, a radio transceiver 38, a memory 32, a removable memory 34 and a plurality of sensors 50ₙ.

The processor 30 controls the display 10 and the indicator(s) 14ₙ. It receives commands from the sensors 50ₙ and it can transfer data to each of the output interface 36, the radio transceiver 38, the memory 32 and the removable memory 34 and can receive data from each of the radio transceiver 38, the memory 32 and the removable memory 34. The output interface 36 and the radio transceiver 38 may be used to access a remote server (not shown). The processor 30 is controlled by a program which controls the device 2 to operate in accordance with the invention and defines the predetermined tasks performed by the device 2. These tasks may include storage of data in the removable memory 34, storage of data in the local memory 32 and storage of data at a remote server using either the output interface 36 or the radio transceiver 38. The task associated with a particular visually identifiable area 8ₙ may be varied by the user.

A first sensor 50₁ is associated with the first visually highlighted area 8₁. It is positioned adjacent the edge of the display 10 closest to the first visually highlighted area 8₁. A second sensor 50₂ is associated with the second visually highlighted area 8₂. It is positioned adjacent the edge of the display 10 closest to the second visually highlighted area 8₂. A third sensor 50₃ is associated with the third visually highlighted area 8₃. It is positioned adjacent the edge of the display 10 closest to the third visually highlighted area 8₃. A fourth sensor 50₄ is associated with the fourth visually highlighted area 8₄. It is positioned adjacent the edge of the display 10 closest to the fourth visually highlighted area 8₄. Each of the sensors 50ₙ may be a pressure sensor which detects when a finger or pointing device touches it or may be an optical sensor which detects when a finger or pointing device is passed over it. Each sensor 50ₙ therefore detects when the element is moved from the display area 6 towards its associated visually identifiable area 8ₘ and informs the processor 30. The processor initiates the associated task.

FIG. 6 illustrates a replaceable cover 60 which is attachable to a hand-portable mobile device 2. The cover 60 provides a portion of the housing 3, the opening 12 and the first 8₁, second 8₂, third 8₃ and fourth 8₄ visually identifiable areas 8ₙ and associated first 14₁, second 14₂, third 14₃ and fourth 14₄ indicators on the front surface of the housing 3 previously described in relation to FIGS. 1 to 5b. The cover has an electrical connector (not shown) which connects with a corresponding electrical connector (not shown) of the device 2 and provides for communication between the processor 30 of the device 2 and the cover 60. When a cover 60 is used in the first embodiment of FIG. 3, the cover may additionally provide part of the user input control 40. When a cover 60 is used in the third embodiment of FIGS. 5a and 5b, the cover may additionally provide the sensors 50ₙ.

Although the present invention has been described with reference to particular embodiments in the preceding paragraphs, it should be appreciated that variations and modifications may be made to these embodiments without departing from the spirit and scope of the invention

I (We) claim:

1. A device for performing a predetermined task associated with a visually identifiable area of the device, comprising a display and a front face having a display area for the display and at least one visually identifiable area at a predetermined position outside the display area wherein movement of an element across at least a portion of the display area towards the visually identifiable area at the predetermined position initiates the associated predetermined task.

2. A device further comprising:
sensing means for sensing movement of an element across at least a portion of the display area towards the visually identifiable area at the predetermined position; and
control means, responsive to the sensing means, arranged to initiate the associated predetermined task when an element is moved across at least a portion of the display area towards the visually identifiable area at the predetermined position.

3. A device as claimed in claim 1 wherein the element is displayed on the display and the device comprises a user input control for moving the element on the display.

4. A device as claimed in claim 2 wherein the sensing means senses movement of the element from a position in front of the display towards the visually identifiable area.

5. A device as claimed in claim 2 wherein the sensing means is a touch sensing means arranged to sense the movement of an element touching the display towards the visually identifiable area.

6. A device as claimed in claim 2 wherein the sensing means comprises a sensor located adjacent at least a portion of the perimeter of the display area.

7. A device as claimed in claim 1 arranged to display an icon on the display and to move the icon across the display with the element.

8. a device as claimed in claim 1 wherein the predetermined task is one of the a plurality of data storage options.

9. A device as claimed in claim 1 wherein the predetermined task is changeable.

10. A device as claimed in claim 1 comprising multiple visually identifiable areas each of which is at a predetermined position and is associated with a predetermined task.

11. A cover for a device as claimed in claim 1 comprising the visually identifiable area of the device.

12. A cover for a device as claimed in claim 2 comprising the visually identifiable area of the device and the sensing means.

13. A device for performing a predetermined task associated with a visually identifiable area of the device face, comprising:
a display;
a front face having a display area for the display and at least one visually identifiable area at a predetermined position outside the display area;
sensing means for sensing movement of an element across at least a portion of the display area towards the visually identifiable area at the predetermined position; and
control means, responsive to the sensing means, arranged to initiate the associated predetermined task.

14. A method of performing a predetermined task associated with a visually identifiable area at a predetermined position outside the display area of a device, comprising the step of:
moving an element from the display area towards the visually identifiable area at the predetermined position.

15. A cover for combination with a device, wherein the combination is arranged to perform a predetermined task associated with a visually identifiable area of the device face in response to user input, comprising:
a housing having a front face with an opening therethrough for a display;
at least one visually identifiable area on the front face of the housing;
an electrical connector for connection to the device; and
a visual indicator electrically connected to the electrical connector.

16. A cover as claimed in claim 15 further comprising at least one sensor located at an edge of the opening adjacent the visually identifiable area.
